(19) United States
(12) Patent Application Publication
(10) Pub. No.: US 2025/0122704 A1
(43) Pub. Date: Apr. 17, 2025

(54) WATER OUTLET DEVICE WITH LIGHT SWITCHING FORCE

(71) Applicant: Xiamen Solex High-Tech Industries Co., Ltd., Xiamen (CN)

(72) Inventors: Xiaolong Lin, Xiamen (CN); Donghai Chen, Xiamen (CN)

(21) Appl. No.: 18/829,381

(22) Filed: Sep. 10, 2024

(30) Foreign Application Priority Data
Oct. 17, 2023 (CN) 202311340545.2

(51) Int. Cl. E03C 1/04

(52) U.S. Cl. CPC E03C 1/0404

(57) ABSTRACT

A water outlet device with a light switching force includes a water outlet device body and a water outlet mode switching assembly. When the switching shaft is in a first position, a first water outlet channel is in communication with a water inlet channel. A movable member is disposed in a second water outlet channel, and the movable member is configured to be moved due to water pressure. A switching shaft is disposed with a position-limiting member and an elastic member. A movable end of the elastic member is located between the position-limiting member and the movable member. When the movable member moves to be in contact with the movable end of the elastic member, the water pressure is counteracted by the elastic member. When the movable member moves to be in contact with the position-limiting member, the water pressure is transmitted to the switching shaft through the position-limiting member.

### RELATED APPLICATIONS

This application claims priority to Chinese patent application number 202311340545.2, filed on Oct. 17, 2023. Chinese patent application number 202311340545.2 is incorporated herein by reference.

### FIELD OF THE DISCLOSURE

The present disclosure relates to a water outlet device, in particular to a water outlet device with a water outlet mode switching function.

### BACKGROUND OF THE DISCLOSURE

Showers, such as shower heads and kitchen sprayers, are some of the most commonly used items in people's daily lives. Nowadays, showers often integrate multiple water flow modes that users can switch between based on different usage scenarios. Currently, some showers on the market require users to press a button to switch the water flow. However, once the switching is complete, users cannot release the button; otherwise, the water flow will revert. This operation method does not align well with user habits. To keep the button in the pressed position after pressing, a mechanical mechanism, such as the structure of a ballpoint pen, can be used, or back pressure formed by the water inside the shower head can be used to hold the button in its current position. For the method using back pressure, to generate enough back pressure even at low water pressure, it is necessary to create a significant difference in the wetted areas at both ends of the switch to achieve sufficient back pressure. However, once the inlet water pressure becomes high, the back pressure inside the showers becomes very large, requiring users to overcome a substantial amount of pressure when pressing the button for switching, resulting in a poor switching experience.

### BRIEF SUMMARY OF THE DISCLOSURE

The technical problem to be solved by the present disclosure is to provide a water outlet device with a light switching force, which can achieve a relatively light switching force under both high and low water pressure conditions.

In order to solve the above technical problems, the present disclosure provides a water outlet device with a light switching force comprising a water outlet device body and a water outlet mode switching assembly.

The water outlet device body has a water inlet channel, a first water outlet channel, and a second water outlet channel.

The water outlet mode switching assembly comprises a first operating member and a switching shaft. The first operating member is configured to drive the switching shaft to move to a first position or a second position. When the switching shaft is in the first position, the first water outlet channel is in communication with the water inlet channel. When the switching shaft is in the second position, the second water outlet channel is in communication with the water inlet channel.

A movable member is disposed in the second water outlet channel, and the movable member is configured to be moved along an axial direction of the switching shaft due to water pressure. The switching shaft is disposed with a position-limiting member and an elastic member. A movable end of the elastic member is located between the position-limiting member and the movable member. When the movable member moves due to the water pressure to be in contact with the movable end of the elastic member, the water pressure acting on the movable member is counteracted by an elastic resetting force of the elastic member. When the movable member moves due to the water pressure to be in contact with the position-limiting member, the water pressure acting on the movable member is transmitted to the switching shaft through the position-limiting member.

The present disclosure provides a water outlet device with a light switching force comprising a water outlet device body and a water outlet mode switching assembly.

The water outlet device body has a water inlet channel, a first water outlet channel, and a second water outlet channel.

The water outlet mode switching assembly comprises a first operating member and a switching shaft. The first operating member is configured to drive the switching shaft to move to a first position or a second position. When the switching shaft is in the first position, the first water outlet channel is in communication with the water inlet channel. When the switching shaft is in the second position, the second water outlet channel is in communication with the water inlet channel.

A movable member is disposed in the second water outlet channel, the movable member is configured to be moved along an axial direction of the switching shaft due to water pressure. The switching shaft is disposed with a position-limiting member and an elastic member. A movable end of the elastic member is located between the position-limiting member and the movable member. When the movable member moves due to the water pressure to be in contact with the movable end of the elastic member, a difference in wetted areas at two ends of the switching shaft is S1. When the movable member moves due to the water pressure to be in contact with the position-limiting member, the difference in the wetted areas at the two ends of the switching shaft is S2. The S1>the S2.

In a preferred embodiment, the movable member comprises a positioning plate sleeved outside the switching shaft.

In a preferred embodiment, a sidewall of the switching shaft comprises a buckling groove extending along a circumferential direction of the switching shaft, and the position-limiting member is a retaining ring that is buckled to the buckling groove.

In a preferred embodiment, the first operating member is a rocker switch, and a distal end of the switching shaft has a spherical head that cooperates with the rocker switch in a linkage manner.

In a preferred embodiment, the water outlet device body comprises a core shaft and a mounting seat which are located inside the water outlet device body, and the switching shaft is disposed in the core shaft. An end portion of the core shaft comprises an opening through which a distal end of the switching shaft passes, and the mounting seat has a position-providing opening through which a first end of the first operating member passes. The mounting seat has buckling openings on two sides of the position-providing opening, and the core shaft comprises buckling blocks configured to be fixedly buckled to the buckling openings.

In a preferred embodiment, a part of the core shaft corresponding to the position-providing opening has a lug, and the lug is disposed with a rotating shaft configured to be rotatably connected to the first operating member.

The mounting seat has mounting posts corresponding to the two sides of the position-providing opening along a length direction of the position-providing opening, and a button cover of the first operating member is respectively connected to the mounting posts by springs.

In a preferred embodiment, the mounting seat is connected to the core shaft to form a water inlet port in communication with the water inlet channel, and a sealing member is sleeved on the switching shaft. When the switching shaft is in the first position, the sealing member is in contact with a first side of the water inlet port to enable the first water outlet channel to be in communication with the water inlet channel. When the switching shaft is in the second position, the sealing member is in contact with a second side of the water inlet port to enable the second water outlet channel to be in communication with the water inlet channel.

In a preferred embodiment, the water outlet device comprises a flow adjustment assembly configured to adjust a water flow area of the water inlet channel.

In a preferred embodiment, the flow adjustment assembly comprises a second operating member, a push rod, and a diverter. The diverter has a first sub-channel and a second sub-channel which are in communication with a water inlet joint, and a sealing gasket is disposed on the push rod. The second operating member is configured to move the push rod from a first position to a second position.

When the push rod is in the first position, the second sub-channel is disconnected from the water inlet joint by the sealing gasket. When the push rod is in the second position, the second sub-channel is connected to the water inlet joint. The first sub-channel is continuously in communication with the water inlet joint.

Compared with the existing techniques, the technical solution has the following advantages.

The present disclosure provides the water outlet device with the light switching force. Under both low and high water pressure conditions, the movable member is driven by the water pressure to move to different positions, thereby changing the difference in the wetted areas at the two ends of the switching shaft. In the low water pressure conditions, the difference in the wetted areas at the two ends of the switching shaft is increased to provide sufficient back pressure to hold the rocker switch in place. Since the water pressure is relatively low, even with an increased difference in the wetted areas at the two ends of the switching shaft, the switching force required to operate the rocker switch remains relatively small. In the high water pressure conditions, the difference in the wetted areas at the two ends of the switching shaft is decreased to lower the required switching force for operating the rocker switch. Even though the water pressure is relatively high, a reduced difference in the wetted areas at the two ends of the switching shaft can decrease back pressure acting on the switching shaft. Thus, the difference in the wetted areas automatically adjusts with changes in the water pressure, ensuring that the switching force required to operate the rocker switch remains small in both the low and high water pressure conditions.

### BRIEF DESCRIPTION OF THE DRAWINGS

FIG. 1 is a perspective view of a water outlet device in a preferred embodiment of the present disclosure.

FIG. 2 is a side view of the water outlet device in the preferred embodiment of the present disclosure.

FIG. 3 is an exploded view of the water outlet device in the preferred embodiment of the present disclosure.

FIG. 4 is a cross-sectional view of the water outlet device in the preferred embodiment of the present disclosure, showing a water flow path when bubble water is being discharged at a low flow rate.

FIG. 5 is a cross-sectional view of the water outlet device in the preferred embodiment of the present disclosure, showing a water flow path when bubble water is being discharged at a high flow rate.

FIG. 6 is a cross-sectional view of the water outlet device in the preferred embodiment of the present disclosure, showing a water flow path when shower water is being discharged at a low flow rate in low water pressure conditions.

FIG. 7 is a cross-sectional view of the water outlet device in the preferred embodiment of the present disclosure, showing a water flow path when shower water is being discharged at a high flow rate in the low water pressure conditions.

FIG. 8 is a cross-sectional view of the water outlet device in the preferred embodiment of the present disclosure, showing a water flow path when shower water is being discharged at a low flow rate in high water pressure conditions.

FIG. 9 is a cross-sectional view of the water outlet device in the preferred embodiment of the present disclosure, showing a water flow path when shower water is being discharged at a high flow rate in the high water pressure conditions.

### DETAILED DESCRIPTION OF THE EMBODIMENTS

The following will clearly and completely describe the technical solutions in the embodiments of the present disclosure with reference to the accompanying drawings. Obviously, the described embodiments are only a portion of the embodiments of the present disclosure, and not all of the embodiments. Based on the embodiments of the present disclosure, all other embodiments obtained by those of ordinary skill in the art without creative work fall within the protection scope of the present disclosure.

In the description of the present disclosure, it should be noted that the terms “upper”, “lower”, “inner”, “outer”, “top end” “bottom end”, etc. indicate the orientation or positional relationship based on the orientation shown in the drawings. The positional relationship is only for the convenience of describing the present disclosure and simplifying the description, rather than indicating or implying that the referenced device or element must have a specific orientation, be constructed, and be operated in a specific orientation. Therefore, the positional relationship should not be understood as a limitation of the present disclosure. In addition, the terms “first” and “second” are only used for descriptive purposes and should not be understood as indicating or implying relative importance.

In the description of the present disclosure, it should be noted that the terms “installed”, “provided with”, “sleeved/connected”, “connected”, etc., should be understood broadly. For example, “connected” can be a wall hanging connection, a detachable connection, or an integral connection, a mechanical connection, an electrical connection, a direct connection, or an indirect connection through an intermediate medium, and it can be a connection in two members. For those of ordinary skill in the art, the specific meaning of the above terms in the present disclosure can be understood under specific conditions.

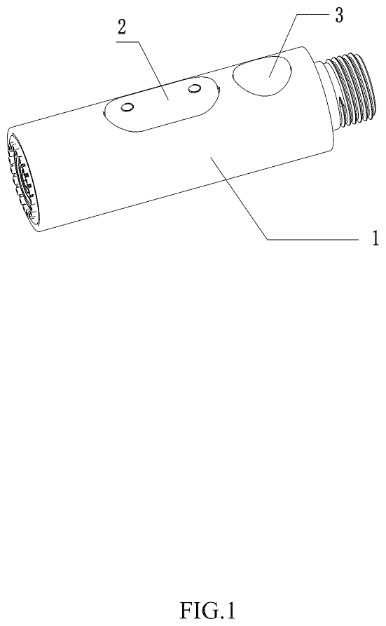

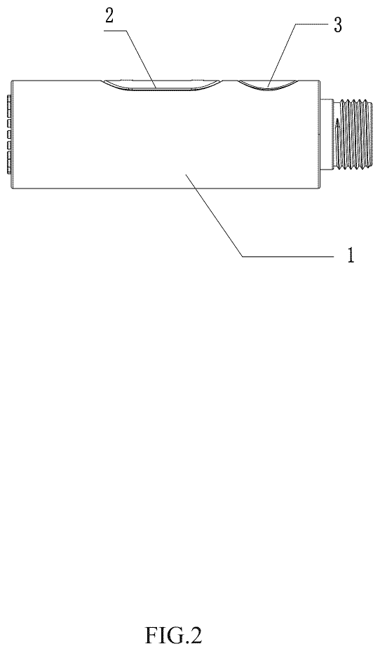

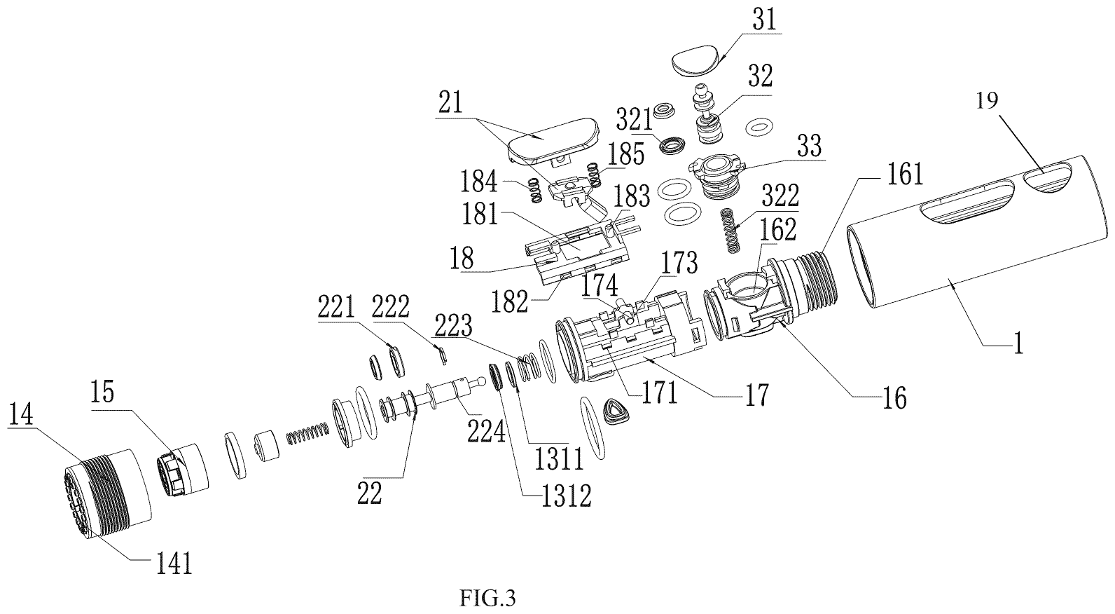

Referring to FIGS. 1-9, this embodiment provides a water outlet device with a light switching force, comprising a water outlet device body 1, a water outlet mode switching assembly 2, and a flow adjustment assembly 3. The water outlet device body 1 has a water inlet channel 11, a first water outlet channel 12, and a second water outlet channel 13.

The water outlet mode switching assembly 2 comprises a first operating member 21 and a switching shaft 22. The first operating member 21 is configured to drive the switching shaft 22 to move to a first position or a second position. When the switching shaft 22 is in the first position, the first water outlet channel 12 is in communication with the water inlet channel 11. When the switching shaft 22 is in the second position, the second water outlet channel 13 is in communication with the water inlet channel 11. In this way, a user can switch a water outlet mode through the first operating member 21. This embodiment comprises two water outlet modes: shower water and bubble water. A plurality of shower water outlet holes 141 are located on a periphery of a bubble water outlet hole. When the switching shaft 22 is in the first position, water is discharged from the bubble water outlet hole. When the switching shaft 22 is in the second position, the water is discharged from the plurality of shower water outlet holes 141.

To arrange the plurality of shower water outlet holes 141 and bubble water outlet hole, a front end of the water outlet device body 1 along an axial direction of the water outlet device body 1 is disposed with a water outlet cover 14. A center of the water outlet cover 14 is disposed with an aerator 15 to form the bubble water outlet hole. The plurality of shower water outlet holes 141 are arranged in a circle around the periphery of the aerator 15 on the water outlet cover 14.

The flow adjustment assembly 3 is configured to adjust a water flow area of the water inlet channel 11, allowing switching between low-flow water discharge and high-flow water discharge. In this embodiment, the flow adjustment assembly 3 comprises a second operating member 31, a push rod 32, and a diverter 33. The diverter 33 has a first sub-channel 331 and a second sub-channel 332 which are in communication with a water inlet joint 161. A sealing gasket 321 is disposed on the push rod 32. The second operating member 31 is configured to move the push rod 32 from a first position to a second position. When the push rod 32 is in the first position, the second sub-channel 332 is disconnected from the water inlet joint 161 by the sealing gasket 321. When the push rod 32 is in the second position, the second sub-channel 332 is connected to the water inlet joint 161. The first sub-channel 331 is continuously in communication with the water inlet joint 161. In this way, when the user operates the second operating member 31 to move the push rod 32 from the first position to the second position, the second sub-channel 332 is connected to the water inlet joint 161, allowing the water flow area of the water inlet channel 11 to be increased and achieving high-flow water discharge.

Additionally, a first resetting spring 322 is disposed on the push rod 32. When the push rod 32 moves to the second position, the push rod 32 compresses the first resetting spring 322, which accumulates an elastic resetting force. In this way, when the user releases the second operating member 31, the first resetting spring 322 releases the elastic resetting force, which drives the push rod 32 back to the first position. In this embodiment, to facilitate user operation, the second operating member 31 is a button.

The above structure allows for switching between the two water outlet modes and between the low-flow water discharge and the high-flow water discharge. Furthermore, the switching of the two water outlet modes and the adjustment of flow rate are independent of each other and do not interfere with one another.

To install the flow adjustment assembly 3, a connector 16 is disposed inside the water outlet device body 1. A threaded section of the connector 16 extends out of the water outlet device body 1, forming the water inlet joint 161. Additionally, a part of the connector 16 disposed in the water outlet device body 1 has an installation cavity 162, which is perpendicular to the axial direction of the water outlet device body 1. The diverter 33 is disposed inside the installation cavity 162, and the push rod 32 is disposed inside the diverter 33. The water outlet device body 1 has a first position-providing opening 19 corresponding to the installation cavity 162, and the button is exposed outside the water outlet device body 1 through the first position-providing opening 19.

In this embodiment, the first operating member 21 is a rocker switch, and a distal end of the switching shaft 22 has a spherical head that cooperates with the rocker switch in a linkage manner.

To install the water outlet mode switching assembly 2, the water outlet device body 1 comprises a core shaft 17 and a mounting seat 18 disposed on a rear end of the connector 16 along a water flow direction. The switching shaft 22 is disposed in the core shaft 17, and an end portion of the core shaft 17 along the water flow direction comprises an opening through which the distal end of the switching shaft 22 passes. The mounting seat 18 has a second position-providing opening 181 through which a first end of the rocker switch passes. After the first end of the rocker switch passes through the second position-providing opening 181, the first end of the rocker switch can be operatively coupled to the spherical head at the distal end of the switching shaft 22, allowing the rocker switch to pull the switching shaft 22 to the first position or second position when pressing the rocker switch. To achieve fixed installation of the mounting seat 18 and the core shaft 17, in this embodiment, the mounting seat 18 has buckling openings 182 on two sides of the second position-providing opening 181. The core shaft 17 comprises buckling blocks 171 that can be fixedly buckled to the buckling openings 182. The core shaft 17 and the mounting seat 18 are fixed in place through the buckling blocks 171 cooperating with the buckling openings 182. Additionally, the core shaft 17 comprises the first water outlet channel 12, the second water outlet channel 13, and a water inlet port 172 connected to the water inlet channel. A sealing member 221 is sleeved on the switching shaft 22. When the switching shaft 22 is in the first position, the sealing member 221 is in contact with a first side of the water inlet port 172 to enable the first water outlet channel 12 to be in communication with the water inlet channel 11. When the switching shaft 22 is in the second position, the sealing member 221 is in contact with a second side of the water inlet port 172 to enable the second water outlet channel 13 to be in communication with the water inlet channel 11. This enables the first water outlet channel 12 and the second water outlet channel 13 to be alternatively in communication with the water inlet channel 11.

Additionally, a part of the core shaft 17 corresponding to the second position-providing opening 181 has a lug 173. The lug 173 is disposed with a rotating shaft 174 configured to be rotatably connected to the rocker switch. This completes installation of the rocker switch. The mounting seat 18 has mounting posts 183 corresponding to two sides of the second position-providing opening 181 along a length direction of the second position-providing opening 181. A button cover of the rocker switch is respectively connected to the mounting posts 183 by a second resetting spring 184 and a third resetting spring 185.

When the water outlet device switches the two water outlet channels (i.e., the first water outlet channel and the second water outlet channel) in a water flow state, the water outlet device will be affected by water pressure. The water pressure varies at different times of the day. To facilitate the user switching the water outlet channels, it is necessary to achieve a light switching force and ease of operation in both low and high water pressure conditions. In this embodiment, a movable member 131 is disposed in the second water outlet channel 13, and the movable member 131 is configured to be moved along an axial direction of the switching shaft 22 due to the water pressure. The switching shaft 22 is disposed with a position-limiting member 222 and an elastic member 223. In this embodiment, the elastic member 223 is a fourth resetting spring sleeved outside of the switching shaft 22. A movable end of the fourth resetting spring is located between the position-limiting member 222 and the movable member 131. When the movable member 131 moves due to the water pressure to be in contact with the movable end of the elastic member 223, the water pressure on the movable member 131 is counteracted by an elastic resetting force of the fourth resetting spring. When the movable member 131 moves due to the water pressure to be in contact with the position-limiting member 222, the water pressure on the movable member 131 is transmitted to the switching shaft 22 through the position-limiting member 222. That is, when the movable member 131 moves due to the water pressure to be in contact with the movable end of the elastic member 223, a difference in wetted areas at two ends of the switching shaft 22 is S1. When the movable member 131 moves due to the water pressure to be in contact with the position-limiting member 222, the difference in the wetted areas at the two ends of the switching shaft 22 is S2. S1>S2. In this way, under low water pressure conditions, the difference in the wetted areas at the two ends of the switching shaft 22 is relatively large, providing sufficient back pressure for the water outlet device. Since this is a low water pressure state, a switching force to drive the switching shaft 22 is also relatively light. Under high water pressure conditions, the difference in the wetted areas at the two ends of the switching shaft 22 is relatively small. The high water pressure provides sufficient back pressure for the water outlet device, and the difference in the wetted areas is small to enable the switching shaft 22 to be in an almost balanced state with respect to the water pressure, resulting in the switching force to drive the switching shaft 22 being light. This achieves a relatively light switching force in both high and low water pressure conditions.

Specifically, the movable member 131 comprises a positioning plate 1311 and a Y-shaped sealing ring 1312, which are sleeved outside the switching shaft 22. Due to the water pressure, the positioning plate 1311 will move relative to the switching shaft 22. The position-limiting member 222 does not move relative to the switching shaft 22. Therefore, a sidewall of the switching shaft 22 comprises a buckling groove 224 extending along a circumferential direction of the switching shaft 22, and the position-limiting member 222 is a retaining ring that is buckled to the buckling groove 224. A purpose of the Y-shaped sealing ring 1312 is to provide sealing. The positioning plate 1311 is used since the Y-shaped sealing ring 1312 is relatively soft and the position-limiting member 222 cannot block the Y-shaped sealing ring 1312. Therefore, the positioning plate 1311 needs to be disposed on a side of the Y-shaped sealing ring 1312 facing the position-limiting member 222. The water pressure is transmitted to the positioning plate 1311 through the Y-shaped sealing ring 1312, and then the water pressure is transmitted to the position-limiting member 222 through the positioning plate 1311.

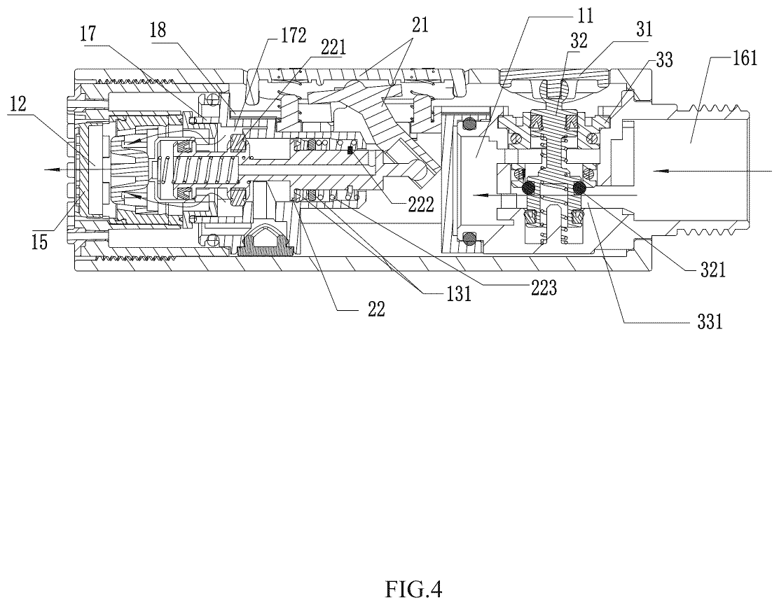

When in use, an initial state is as shown in FIG. 4. The switching shaft 22 is in the first position, and the push rod 32 is in the first position. The first water outlet channel 12 is open, and the second sub-channel 332 is closed. At this time, the bubble water is being discharged at a low flow rate.

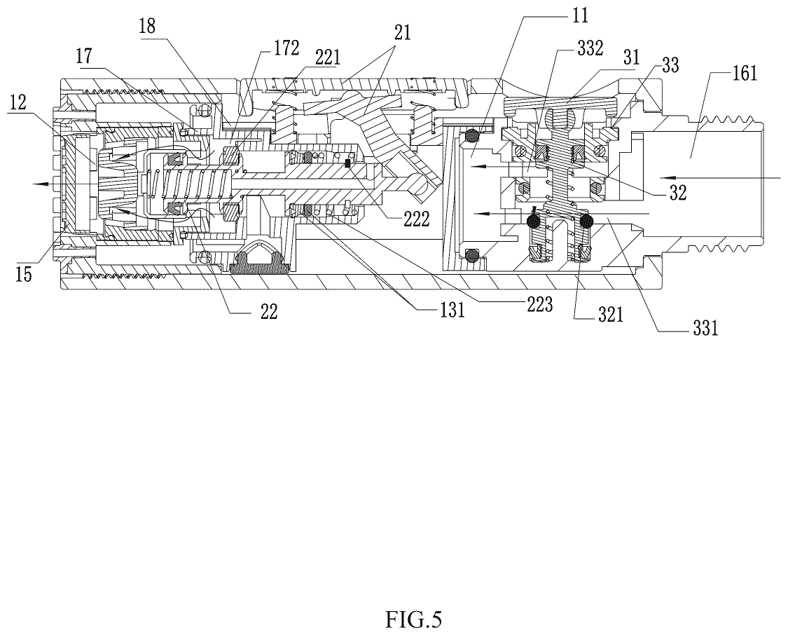

When in a state shown in FIG. 4, the user can press the button, and the push rod 32 will move to the second position, switching to a state shown in FIG. 5. At this time, the second sub-channel 332 is opened, resulting in the bubble water being discharged at a high flow rate.

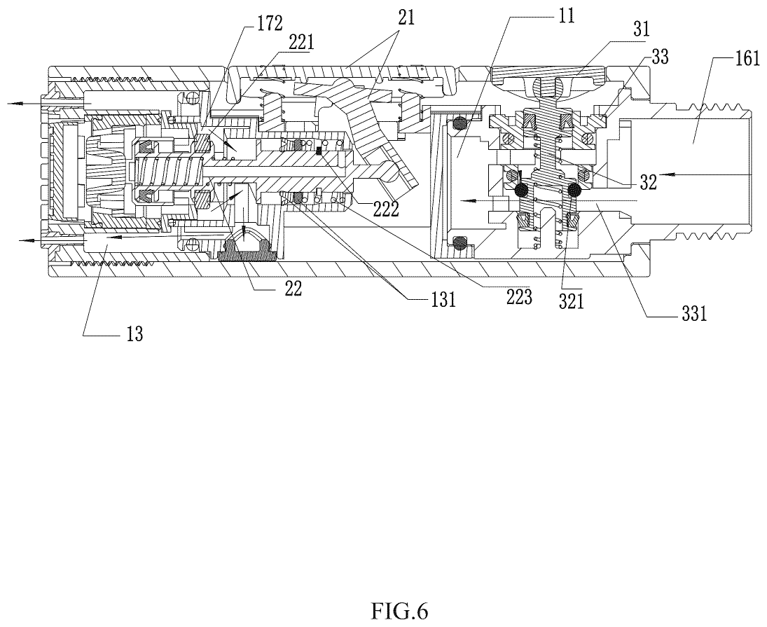

When in the state shown in FIG. 4, the user can press the rocker switch, and the switching shaft 22 will move to the second position, switching to a state shown in FIG. 6. At this time, the first water outlet channel 12 is closed, and the second water outlet channel 13 is opened. This results in the shower water being discharged at a low flow rate. Due to the water pressure being low at this time, the positioning plate 1311 can only move to a position where the positioning plate 1311 is in contact with the fourth resetting spring. A spring force of the fourth resetting spring can balance with the water pressure acting on the positioning plate 1311, enabling the difference in the wetted areas at the two ends of the switching shaft 22 to be larger, and providing sufficient back pressure for the water outlet device. With lower water pressure, the switching force to drive the switching shaft 22 and change the water mode is lighter.

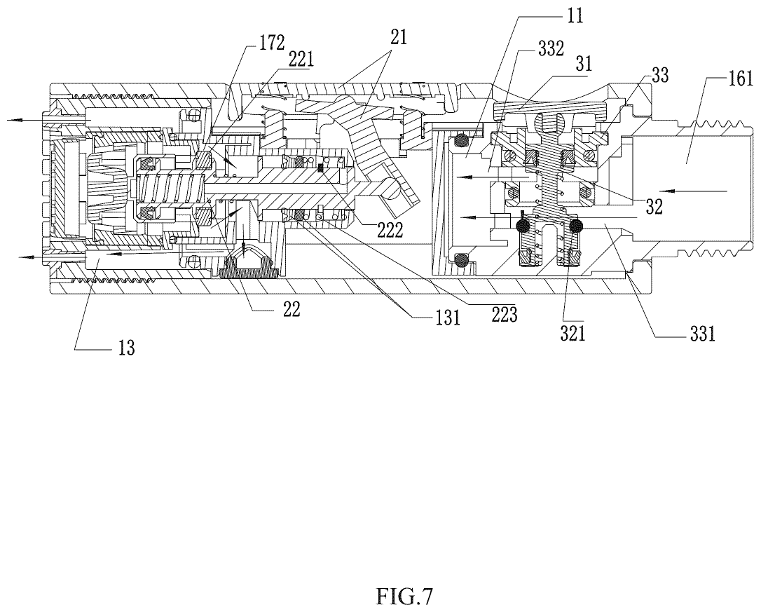

When in the state shown in FIG. 6, the user can press the button, and the push rod 32 will move to the second position, switching to a state shown in FIG. 7. At this time, the second sub-channel 332 is opened, resulting in the shower water being discharged at a high flow rate.

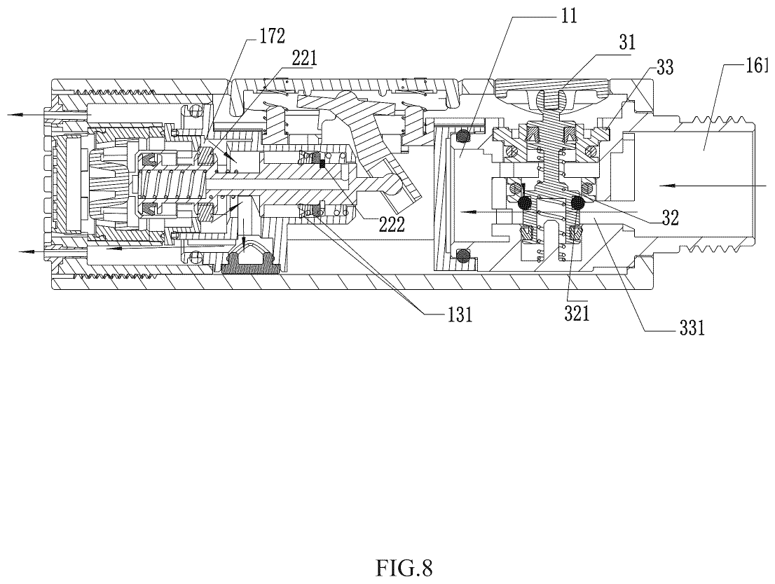

When in the state shown in FIG. 4, the user can press the rocker switch, and the switching shaft 22 will move to the second position, switching to a state shown in FIG. 8. At this time, the first water outlet channel 12 is closed, and the second water outlet channel 13 is opened. This results in the shower water being discharged at a low flow rate. Due to the water pressure being high at this time, the positioning plate 1311 moves to a position where the positioning plate 1311 is supported by the position-limiting member 222, so that the water pressure can be transmitted to the switching shaft 22. At this point, the difference in the wetted areas at the two ends of the switching shaft 22 decreases significantly to S2, approaching water pressure balance. High water pressure provides sufficient back pressure for the water outlet device. With the water pressure approaching balance, the switching force to drive the switching shaft 22 and change the water mode is lighter.

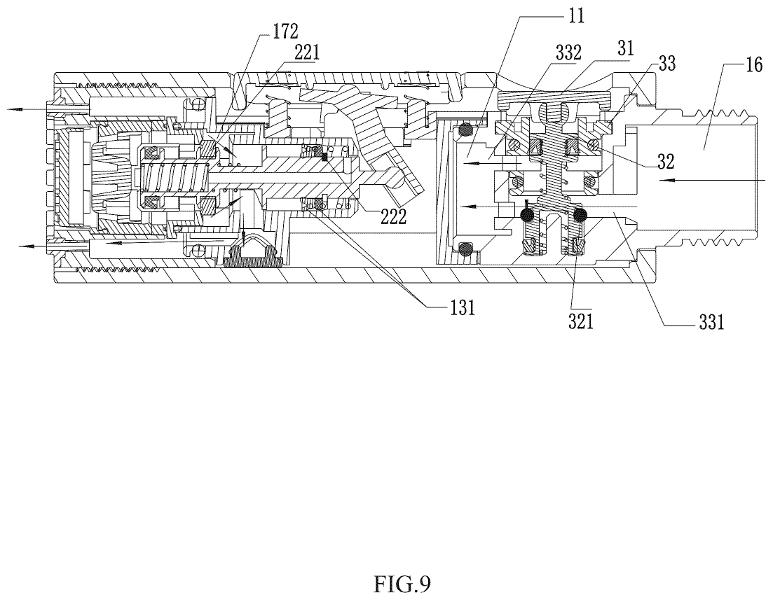

When in a state shown in FIG. 8, the user can press the button, and the push rod 32 will move to the second position, switching to a state shown in FIG. 9. At this time, the second sub-channel 332 is opened, resulting in the shower water being discharged at a high flow rate.

The aforementioned embodiments are merely some embodiments of the present disclosure, and the scope of the disclosure is not limited thereto. Thus, it is intended that the present disclosure cover non-substantive modifications of the present disclosure provided they are made based on the concept within the technical scope disclosed in the present disclosure by any technical person skilled in the art.

What is claimed is:

1. A water outlet device with a light switching force, comprising:
a water outlet device body, and
a water outlet mode switching assembly, wherein:
the water outlet device body has a water inlet channel, a first water outlet channel, and a second water outlet channel,
the water outlet mode switching assembly comprises a first operating member and a switching shaft,
the first operating member is configured to drive the switching shaft to move to a first position or a second position,
when the switching shaft is in the first position, the first water outlet channel is in communication with the water inlet channel,
when the switching shaft is in the second position, the second water outlet channel is in communication with the water inlet channel,
a movable member is disposed in the second water outlet channel,
the movable member is configured to be moved along an axial direction of the switching shaft due to water pressure,
the switching shaft is disposed with a position-limiting member and an elastic member,
a movable end of the elastic member is located between the position-limiting member and the movable member,
when the movable member moves due to the water pressure to be in contact with the movable end of the elastic member, the water pressure acting on the movable member is counteracted by an elastic resetting force of the elastic member, and
when the movable member moves due to the water pressure to be in contact with the position-limiting member, the water pressure acting on the movable member is transmitted to the switching shaft through the position-limiting member.

2. The water outlet device with the light switching force according to claim 1, wherein:
the movable member comprises a positioning plate sleeved outside the switching shaft.

3. The water outlet device with the light switching force according to claim 1, wherein:
a sidewall of the switching shaft comprises a buckling groove extending along a circumferential direction of the switching shaft, and
the position-limiting member is a retaining ring that is buckled to the buckling groove.

4. The water outlet device with the light switching force according to claim 1, wherein:
the first operating member is a rocker switch, and
a distal end of the switching shaft has a spherical head that cooperates with the rocker switch in a linkage manner.

5. The water outlet device with the light switching force according to claim 1, wherein:
the water outlet device body comprises a core shaft and a mounting seat which are located inside the water outlet device body,
the switching shaft is disposed in the core shaft,
an end portion of the core shaft comprises an opening through which a distal end of the switching shaft passes,
the mounting seat has a position-providing opening through which a first end of the first operating member passes,
the mounting seat has buckling openings on two sides of the position-providing opening, and
the core shaft comprises buckling blocks configured to be fixedly buckled to the buckling openings.

6. The water outlet device with the light switching force according to claim 5, wherein:
a part of the core shaft corresponding to the position-providing opening has a lug,
the lug is disposed with a rotating shaft configured to be rotatably connected to the first operating member,
the mounting seat has mounting posts corresponding to the two sides of the position-providing opening along a length direction of the position-providing opening, and
a button cover of the first operating member is respectively connected to the mounting posts by springs.

7. The water outlet device with the light switching force according to claim 5, wherein:
the mounting seat is connected to the core shaft to form a water inlet port in communication with the water inlet channel,
a sealing member is sleeved on the switching shaft,
when the switching shaft is in the first position, the sealing member is in contact with a first side of the water inlet port to enable the first water outlet channel to be in communication with the water inlet channel, and
when the switching shaft is in the second position, the sealing member is in contact with a second side of the water inlet port to enable the second water outlet channel to be in communication with the water inlet channel.

8. The water outlet device with the light switching force according to claim 1, comprising:
a flow adjustment assembly configured to adjust a water flow area of the water inlet channel.

9. The water outlet device with the light switching force according to claim 8, wherein:
the flow adjustment assembly comprises a second operating member, a push rod, and a diverter,
the diverter has a first sub-channel and a second sub-channel which are in communication with a water inlet joint,
a sealing gasket is disposed on the push rod,
the second operating member is configured to move the push rod from a first position to a second position,
when the push rod is in the first position, the second sub-channel is disconnected from the water inlet joint by the sealing gasket,
when the push rod is in the second position, the second sub-channel is connected to the water inlet joint, and
the first sub-channel is continuously in communication with the water inlet joint.

10. A water outlet device with a light switching force, comprising:
a water outlet device body, and
a water outlet mode switching assembly, wherein:
the water outlet device body has a water inlet channel, a first water outlet channel, and a second water outlet channel,
the water outlet mode switching assembly comprises a first operating member and a switching shaft,
the first operating member is configured to drive the switching shaft to move to a first position or a second position,
when the switching shaft is in the first position, the first water outlet channel is in communication with the water inlet channel,
when the switching shaft is in the second position, the second water outlet channel is in communication with the water inlet channel,
a movable member is disposed in the second water outlet channel,
the movable member is configured to be moved along an axial direction of the switching shaft due to water pressure,
the switching shaft is disposed with a position-limiting member and an elastic member,
a movable end of the elastic member is located between the position-limiting member and the movable member,
when the movable member moves due to the water pressure to be in contact with the movable end of the elastic member, a difference in wetted areas at two ends of the switching shaft is S1,
when the movable member moves due to the water pressure to be in contact with the position-limiting member, the difference in the wetted areas at the two ends of the switching shaft is S2, and
the S1>the S2.

11. The water outlet device with the light switching force according to claim 10, wherein:
the movable member comprises a positioning plate sleeved outside the switching shaft.

12. The water outlet device with the light switching force according to claim 10, wherein:
a sidewall of the switching shaft comprises a buckling groove extending along a circumferential direction of the switching shaft, and
the position-limiting member is a retaining ring that is buckled to the buckling groove.

13. The water outlet device with the light switching force according to claim 10, wherein:
the first operating member is a rocker switch, and
a distal end of the switching shaft has a spherical head that cooperates with the rocker switch in a linkage manner.

14. The water outlet device with the light switching force according to claim 10, wherein:
the water outlet device body comprises a core shaft and a mounting seat which are located inside the water outlet device body,
the switching shaft is disposed in the core shaft,
an end portion of the core shaft comprises an opening through which a distal end of the switching shaft passes,
the mounting seat has a position-providing opening through which a first end of the first operating member passes,
the mounting seat has buckling openings on two sides of the position-providing opening, and
the core shaft comprises buckling blocks configured to be fixedly buckled to the buckling openings.

15. The water outlet device with the light switching force according to claim 14, wherein:
a part of the core shaft corresponding to the position-providing opening has a lug,
the lug is disposed with a rotating shaft configured to be rotatably connected to the first operating member,
the mounting seat has mounting posts corresponding to the two sides of the position-providing opening along a length direction of the position-providing opening, and
a button cover of the first operating member is respectively connected to the mounting posts by springs.

16. The water outlet device with the light switching force according to claim 14, wherein:
the mounting seat is connected to the core shaft to form a water inlet port in communication with the water inlet channel,
a sealing member is sleeved on the switching shaft,
when the switching shaft is in the first position, the sealing member is in contact with a first side of the water inlet port to enable the first water outlet channel to be in communication with the water inlet channel, and
when the switching shaft is in the second position, the sealing member is in contact with a second side of the water inlet port to enable the second water outlet channel to be in communication with the water inlet channel.

17. The water outlet device with the light switching force according to claim 10, comprising:
a flow adjustment assembly configured to adjust a water flow area of the water inlet channel.

18. The water outlet device with the light switching force according to claim 17, wherein:
the flow adjustment assembly comprises a second operating member, a push rod, and a diverter,
the diverter has a first sub-channel and a second sub-channel which are in communication with a water inlet joint,
a sealing gasket is disposed on the push rod,
the second operating member is configured to move the push rod from a first position to a second position,
when the push rod is in the first position, the second sub-channel is disconnected from the water inlet joint by the sealing gasket,
when the push rod is in the second position, the second sub-channel is connected to the water inlet joint, and
the first sub-channel is continuously in communication with the water inlet joint.
